(19) United States
(12) Patent Application Publication
(10) Pub. No.: US 2003/0092436 A1
(43) Pub. Date: May 15, 2003

(54) System and method for re-use of a terminating telephone number with multiple mobile telephones

(76) Inventor: Roger Boivin, Melissa, TX (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/290,202

(22) Filed: Nov. 8, 2002

Related U.S. Application Data
(60) Provisional application No. 60/331,179, filed on Nov. 9, 2001.

(51) Int. Cl. H04M 3/00

(52) U.S. Cl. 455/419; 455/418

(57) ABSTRACT

A system and method allows re-use of the same terminating telephone number with multiple mobile telephones, as when a user of a disposable cell phone obtains another such phone and wants to keep the same number. A system for connecting an incoming call to a mobile telephone comprises a server platform connected to a public switch telephone network and to a mobile switching center of and operable to receive calls from the public switch telephone network and mobile telephones and operable to place calls to the public switch telephone network and to mobile telephones, the server platform comprising a server operable to receive a call from a newly activated mobile telephone, the call being a first call made from the mobile telephone, determine that the newly activated mobile telephone is newly activated, determine whether a user of the newly activated mobile telephone is a returning user of a previous mobile telephone, obtain from the user of the newly activated mobile telephone a telephone number of the previous mobile telephone, and assign the telephone number of the previous mobile telephone to the newly activated mobile telephone.

### CROSS-REFERENCE TO RELATED APPLICATIONS

The benefit under 35 U.S.C. §119(e) of provisional application No. 60/331,179, filed Nov. 9, 2001, is hereby claimed.

### FIELD OF THE INVENTION

The present invention relates to a system and method that allows re-use of the same terminating telephone number with multiple mobile telephones, such as when a user of a disposable cell phone obtains another disposable phone and wants to keep the same number.

### BACKGROUND OF THE INVENTION

Mobile telecommunications, such as that provided by wireless telephones, has become increasingly popular and widespread. With this increasing popularity has come a proliferation of mobile telephone plans, with a proliferation of fees, features, and restrictions. Most such plans require a relatively large initial investment and a continuing monthly fee, regardless of usage. While such plans may meet the needs of many users, they do not meet the needs of many other users. For example, a user may desire a mobile telephone to be available for emergency use only. Likewise, a user may desire short-term service for themselves while on a trip or for visitors while being visited. These uses are not really compatible with the typical initial investment and continuing fee required by most mobile telephone plans. In these and many other situations, a need arises for a mobile telephone that requires a reasonable initial investment and no continuing fee.

Conventional solutions to such needs include pay-per-use, prepaid, and rental mobile telephones. However, these solutions have disadvantages in that they typically still require relatively large initial investments, contracts, and/or deposits on the part of the user. A better solution is the recyclable/disposable mobile telephone, which requires only a reasonable initial investment by the user and does not require contracts or deposits.

One problem that arises with the recyclable/disposable mobile telephone is that conventionally, each such recyclable/disposable mobile telephone has a different telephone number and the user of the recyclable/disposable mobile telephone must communicate a new telephone number to potential callers each time the user obtains a new recyclable/disposable mobile telephone.

### SUMMARY OF THE INVENTION

The present invention is a system and method allows re-use of the same terminating telephone number with multiple mobile telephones, such as when a user of a disposable cell phone obtains another disposable phone and wants to keep the same number.

In one embodiment of the present invention, a system for connecting an incoming call to a mobile telephone comprises a server platform connected to a public switch telephone network and to a mobile switching center of a mobile telephone network and operable to receive calls from the public switch telephone network and from mobile telephones in the mobile telephone network and operable to place calls to the public switch telephone network and to mobile telephones in the mobile telephone network, the server platform comprising a server operable to receive a call from a newly activated mobile telephone, the call being a first call made from the mobile telephone, determine that the newly activated mobile telephone is newly activated, determine whether a user of the newly activated mobile telephone is a returning user of a previous mobile telephone, obtain from the user of the newly activated mobile telephone a telephone number of the previous mobile telephone, and assign the telephone number of the previous mobile telephone to the newly activated mobile telephone.

In one aspect of the present invention, the newly activated mobile telephone is a recyclable/disposable telephone. The previous mobile telephone may be a recyclable/disposable telephone. The first call made from the mobile telephone may be dialed to a first telephone number, but may be routed to a second telephone number. The server may be operable to determine that the newly activated mobile telephone is newly activated based on a mobile identification number of the newly activated mobile telephone. The server platform may further comprise an interactive voice response unit operable to prompt the user to input information using the newly activated mobile telephone that indicates whether the user is a returning user of a previous mobile telephone. The server platform may further comprise an interactive voice response unit operable to prompt the user to input information indicating whether the user desires to keep or use the telephone number of the previous mobile telephone for the newly activated mobile telephone and prompting the user to enter the telephone number of the previous mobile telephone. The server platform may further comprise a database comprising information relating to the telephone number of the previous mobile telephone is currently inactive. The server may be further operable to access the database to determine whether the telephone number of the previous mobile telephone is currently inactive.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a typical mobile communications network, which may function in conjunction with the present invention.

FIG. 2 is an exemplary block diagram of a mobile communications network, in which the present invention may be implemented.

FIG. 3 is an exemplary flow diagram of a process of operation of the present invention.

FIG. 4 is an exemplary block diagram of a server system shown in FIG. 2.

### DETAILED DESCRIPTION OF THE INVENTION

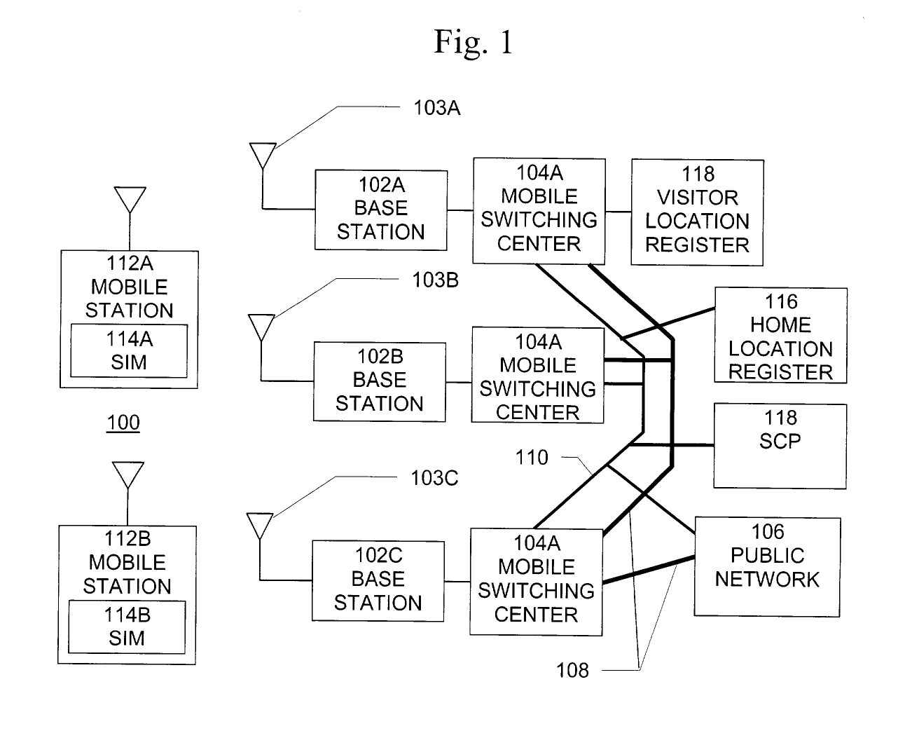

An exemplary block diagram of a typical mobile communications network 100, which may function in conjunction with the present invention, is shown in FIG. 1. Such a mobile network includes a plurality of base stations, such as base stations 102A-C. Each base station, such as base station 102A, typically includes a plurality of base station transceivers, which are part of a base station cluster controlled by a single base station controller. Each base station transceiver transmits and receives radio signals on its corresponding antenna 103A-C and each such transceiver antenna unit covers an area known as a cell. For much of the network, base station transceivers are organized in a seven cell or twelve cell repeat pattern with tri-sectored coverage for each. Thus, seven or twelve base station transceivers are typically connected to each base station controller. Most base station transceivers have between 20 and 30 voice channels with one signaling channel carrying all of the paging and access functions per cell.

Each base station, such as base station 102A, is connected to a mobile switching center (MSC), such as MSC 104A. MSC 104A is a digital switching system with a distributed control architecture especially adapted for operation in the cellular environment. The base stations 102A-C are typically connected to their corresponding MSCs 104A-C and the public (landline) telephone network 106 over digital lines 108. The MSCs 104A-C handle the switching of call traffic between base stations and the landline telephone network, public network 106. MSCs 104A-C are also connected by a signaling network 110, over which a variety of signaling messages are communicated.

The system also includes a plurality of mobile telephones, such as mobile telephones 112A-B, which receive and transmit radio signals with the antenna 103A-C of the base station 102A-C with which the mobile telephone is communicating. Each mobile telephone 112A-B may include a subscriber identity module (SIM), such as SIM 114A-B. Designed to be inserted into a mobile telephone, a SIM or “smart” card contains subscriber-related data, such as phone numbers, service details, and memory for storing messages. With a SIM card, calls can be made from any valid mobile phone because the subscriber data—not the telephone's internal serial number—is used to make the call

Associated with mobile communications network 100 is home location register (HLR) 116. HLR 116 stores management data relating to all of the mobile telephones 112A-B for which network 100 is the home network. Each MSC 104A-C is associated with an HLR 116 in the network. In principle there need be only one HLR 116 for the entire mobile network. In practice, there are generally several so as to accommodate the large quantity of data, which is required to be stored in the HLR 116. This data includes the international mobile station identity (IMSI), the mobile telephone profile of capacities and services unique to the mobile telephone 112A-B, and the location of the mobile telephone 112A-B within the overall mobile network. HLR 116 is connected over signaling network 110 to the MSCs 104A-C in the network.

Associated with each MSC 104A-C is a visitor location register (VLR) 118. Each MSC 104A-C typically has its own VLR 118, but this is not required. VLR 118 stores selected data relating to mobile telephones 112A-B that are visiting within the network associated with VLR 118 and its MSC 104A-C. The data stored in VLR 118 is transferred from the home location register of the home network to VLR 118 for each mobile telephone 112A-B within the network of the VLR. This data can include the international mobile station identity (IMSI), the mobile station international ISDN number, and other information, including the current geographic location of the mobile telephone 112A-B, and the services available to the mobile telephone 112A-B, for example supplementary voice services or data services.

The VLR servicing a geographic area is continually updated with the locations of every mobile telephone within its service area as each mobile telephone registers or otherwise communicates with the system. In addition, the HLR is updated with the current serving MSC of each active mobile telephone allocated to it. This location is typically in the form of the particular cell—base station, base station transceiver, and antenna—in which the mobile telephone is located.

Mobile network 100 may also include service control point (SCP) 118. SCP 118 is a database that supplies the translation and routing data needed to provide advanced network services in signaling network 110. SCP 118 translates special service numbers, such as 800 numbers, to provide the required routing number.

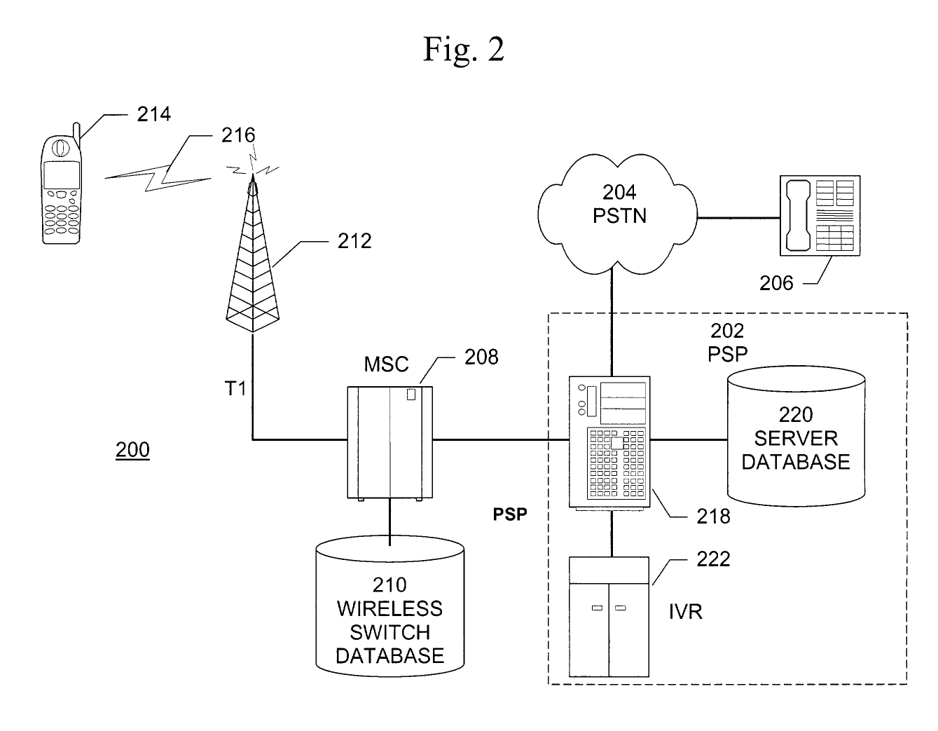

An exemplary block diagram of a mobile communications network 200, in which the present invention may be implemented, is shown in FIG. 2. Network 200 includes prepaid server platform (PSP) 202, public switch telephone network (PSTN) 204, telephone station 206, mobile switching center (MSC) 208, wireless switch database 210, base station 212, and mobile telephone 214. The network shown in FIG. 2 is merely an example. One of skill in the art would recognize that a network in which the present invention may be implemented may include multiple instances of elements shown in FIG. 2, as well as additional elements, such as those shown in FIG. 1.

Mobile telephone 214 receive and transmit radio signals over radio frequency links 216A and 216B, respectively, with the antenna of the base station 212 with which the mobile telephone is communicating. Preferably, mobile telephone 214 are disposable/recyclable wireless or cellular telephones (RDP) and will be referred to as such for this example.

Base station 212 is connected to MSC 208. MSC 208 is a digital switching system with a distributed control architecture especially adapted for operation in the cellular environment. Base stations 212 is typically connected MSC 208 over digital lines, such as a T1 line. MSC 208 handles the switching of call traffic between base station 212 and PSP 202.

MSC 208 is connected to wireless switch database 210 and PSP 202. PSP 202 includes prepaid service server 218, server database system 220, and interactive voice response (IVR) unit 222. Server 218 handles calls placed between mobile telephone 214 and PSTN 204. Server database system 220 stores data needed by server 218 in order to handle the calls and perform the appropriate billing. IVR 222 provides interactive voice response to callers in order to facilitate the handling of calls by server 218. As one of skill in the art would recognize, server database system 220 and/or IVR 222 may be included in server 218, or they may be implemented separately from server 218. The present invention contemplates any and all such arrangements.

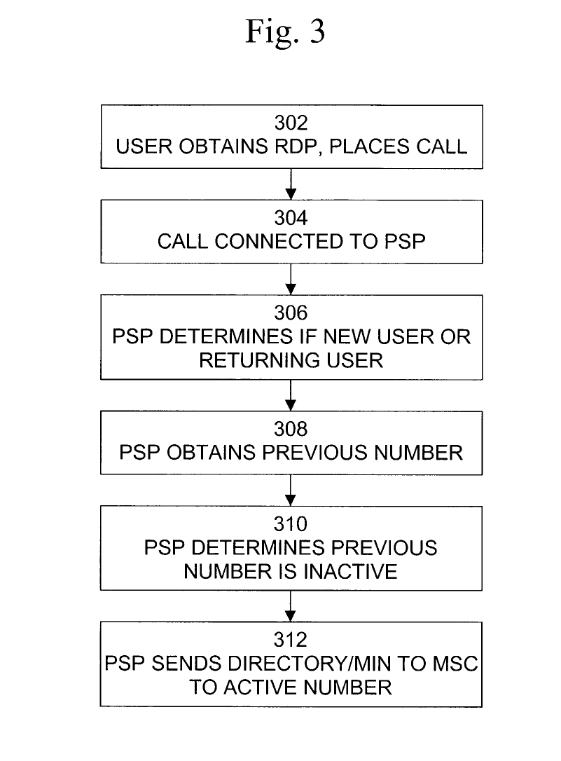

An exemplary flow diagram of a process 300 of operation of the present invention is shown in FIG. 3. It is best viewed in conjunction with FIG. 2. Process 300 begins with step 302, in which a user obtains a first recyclable/disposable telephone, such as RDP 214. At some point the user activates RDP 214 and places a first call. In step 304, regardless of the number dialed by the user, this first call is connected by MSC 208 to PSP 202 based on the Mobile Identification Number (MIN) of RDP 214. The MIN is a typically ten digit number that is used to uniquely identify a mobile telephone, such as an Advanced Mobile Phone Service (AMPS) or Code Division Multiple Access (CDMA) mobile telephone. Typically, this first call is connected by MSC 208 to PSP 202 using a toll-free access number, such as a 1-800 number. Within PSP 202, the call is connected to server 218. Server 218 determines that RDP 214 is newly activated, based on the MIN of RDP 214. For example, server 218 receives the MIN of RDP 214, accesses database 220 using the MIN of RDP 214 to obtain information relating to RDP 214, and based upon this information, determines that RDP 214 is newly activated.

As a result of determining that RDP 214 is newly activated, in step 306, server 218 connects the call to IVR 222, which interacts with the user. In particular, IVR 222 prompts the user to input information using RDP 214 that indicates whether the user is a new user of recyclable/disposable telephones, or whether the user is a returning user of one or more previous recyclable/disposable telephones. If the user is a new user of recyclable/disposable telephones, the default telephone number of RDP 214 is retained and the call is completed.

If the user is a returning user of one or more previous recyclable/disposable telephones, IVR 222 prompts the user to input information indicating whether the user desires to keep/use the same telephone number for RDP 214 that the user used for the previous recyclable/disposable telephone(s). If the user does not desire to keep/use the same telephone number for RDP 214 that the user used for previous recyclable/disposable telephone(s), the default telephone number of RDP 214 is retained and the call is completed.

If the user does desire to keep/use the same telephone number for RDP 214 that the user used for previous recyclable/disposable telephone(s), then in step 308, IVR 222 prompts the user to enter the previously used telephone number and confirms the entered telephone number. In step 310, server 218 determines that the entered telephone number is currently inactive, and so is available for use. In particular, server 218 accesses database 220 using the entered telephone number to obtain information indicating that the entered telephone number is inactive.

If the entered telephone number is not currently inactive, it cannot be assigned to RDP 214, so the default telephone number of RDP 214 is retained and the call is completed. Optionally, IVR 222 may prompt the user to enter another previously used telephone number and step 310 may be repeated using that telephone number.

If the entered telephone number is currently inactive, then in step 312, the entered telephone number is assigned to RDP 214. In particular, server 218 sends a directory/MIN combination to MSC 208, which stores the association of the entered telephone number and the MIN of RDP 214 and activates the entered telephone number as the number of RDP 214.

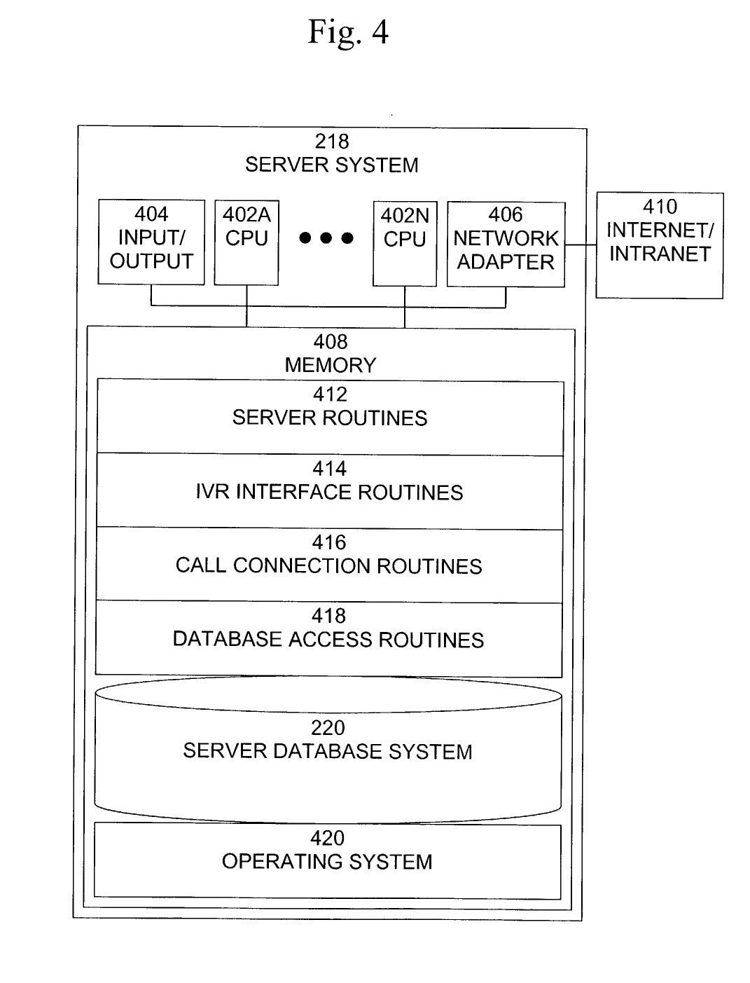

An exemplary block diagram of a server system 400 shown in FIG. 2, is shown in FIG. 4. System 400 is typically a programmed general-purpose computer system, such as a personal computer, workstation, server system, and minicomputer or mainframe computer. System 400 includes one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which System 400 is implemented as a single multi-processor computer system, in which multiple processors 402A-402N share system resources, such as memory 408, input/output circuitry 404, and network adapter 406. However, the present invention also contemplates embodiments in which System 400 is implemented as a plurality of networked computer systems, which may be single-processor computer systems, multi-processor computer systems, or a mix thereof.

Input/output circuitry 404 provides the capability to input data to, or output data from, database/System 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces database/System 400 with Internet/intranet 410. Internet/intranet 410 may include one or more standard local area network (LAN) or wide area network (WAN), such as Ethernet, Token Ring, the Internet, or a private or proprietary LAN/WAN.

Memory 408 stores program instructions that are executed by, and data that are used and processed by, CPU 402 to perform the functions of system 400. Memory 408 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 4, memory 408 includes server routines 412, IVR interface routines 414, call connection routines 416, database access routines 418, and operating system 428. Server system 218 may also include server database system 220. one of skill in the art would recognize that these functions, along with the memory contents related to those functions, may be included on one system, or may be distributed among a plurality of systems, based on well-known engineering considerations. The present invention contemplates any and all such arrangements. For example, server database system 220 and/or IVR 222 may be included in server 218, or they may be implemented separately from server 218.

Server routines 412 include software that implements the functionality of prepaid server platform 202, shown in FIG. 1. IVR interface routines 414 provide the capability to interface an IVR, such as IVR 222, with server system 218 and to interoperate with the IVR. Call connection routines 416 provide the capability to connect calls with mobile telephones, such as RDP 214, in order to perform process 300, shown in FIG. 3. Database access routines provide the capability to access server database system 220, in order to perform process 300. Operating system 420 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX@, OS/2′, and WINDOWS@, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multitasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for re-use of a terminating telephone number with multiple mobile telephones comprising the steps of:
receiving a call from a newly activated mobile telephone, the call being a first call made from the mobile telephone;
determining that the newly activated mobile telephone is newly activated;
determining whether a user of the newly activated mobile telephone is a returning user of a previous mobile telephone;
obtaining from the user of the newly activated mobile telephone a telephone number of the previous mobile telephone; and
assigning the telephone number of the previous mobile telephone to the newly activated mobile telephone.

2. The method of claim 1, wherein the newly activated mobile telephone is a recyclable/disposable telephone.

3. The method of claim 2, wherein the previous mobile telephone is a recyclable/disposable telephone.

4. The method of claim 3, wherein the first call made from the mobile telephone is dialed to a first telephone number, but is routed to a second telephone number.

5. The method of claim 4, wherein the step of determining that the newly activated mobile telephone is newly activated comprises the step of:
determining that the newly activated mobile telephone is newly activated based on a mobile identification number of the newly activated mobile telephone.

6. The method of claim 5, wherein the step of determining whether a user of the newly activated mobile telephone is a returning user of a previous mobile telephone comprises the step of:
prompting the user to input information using the newly activated mobile telephone that indicates whether the user is a returning user of a previous mobile telephone.

7. The method of claim 6, wherein the step of obtaining from the user of the newly activated mobile telephone a telephone number of the previous mobile telephone comprises the steps of:
prompting the user to input information indicating whether the user desires to keep or use the telephone number of the previous mobile telephone for the newly activated mobile telephone; and
prompting the user to enter the telephone number of the previous mobile telephone.

8. The method of claim 7, further comprising the step of:
determining whether the telephone number of the previous mobile telephone is currently inactive.

9. A system for re-use of a terminating telephone number with multiple mobile telephones comprising:
a processor operable to execute computer program instructions;
a memory operable to store computer program instructions executable by the processor; and
computer program instructions stored in the memory and executable to perform the steps of:
receiving a call from a newly activated mobile telephone, the call being a first call made from the mobile telephone;
determining that the newly activated mobile telephone is newly activated;
determining whether a user of the newly activated mobile telephone is a returning user of a previous mobile telephone;
obtaining from the user of the newly activated mobile telephone a telephone number of the previous mobile telephone; and
assigning the telephone number of the previous mobile telephone to the newly activated mobile telephone.

10. The system of claim 9, wherein the newly activated mobile telephone is a recyclable/disposable telephone.

11. The system of claim 10, wherein the previous mobile telephone is a recyclable/disposable telephone.

12. The system of claim 11, wherein the first call made from the mobile telephone is dialed to a first telephone number, but is routed to a second telephone number.

13. The system of claim 12, wherein the step of determining that the newly activated mobile telephone is newly activated comprises the step of:
determining that the newly activated mobile telephone is newly activated based on a mobile identification number of the newly activated mobile telephone.

14. The system of claim 13, wherein the step of determining whether a user of the newly activated mobile telephone is a returning user of a previous mobile telephone comprises the step of:
prompting the user to input information using the newly activated mobile telephone that indicates whether the user is a returning user of a previous mobile telephone.

15. The system of claim 14, wherein the step of obtaining from the user of the newly activated mobile telephone a telephone number of the previous mobile telephone comprises the steps of:
prompting the user to input information indicating whether the user desires to keep or use the telephone number of the previous mobile telephone for the newly activated mobile telephone; and
prompting the user to enter the telephone number of the previous mobile telephone.

16. The system of claim 15, further comprising the step of:
determining whether the telephone number of the previous mobile telephone is currently inactive.

17. A computer program product for re-use of a terminating telephone number with multiple mobile telephones comprising:
a computer readable medium;
computer program instructions, recorded on the computer readable medium, executable by a processor, for performing the steps of
receiving a call from a newly activated mobile telephone, the call being a first call made from the mobile telephone;
determining that the newly activated mobile telephone is newly activated;
determining whether a user of the newly activated mobile telephone is a returning user of a previous mobile telephone;
obtaining from the user of the newly activated mobile telephone a telephone number of the previous mobile telephone; and
assigning the telephone number of the previous mobile telephone to the newly activated mobile telephone.

18. The computer program product of claim 17, wherein the newly activated mobile telephone is a recyclable/disposable telephone.

19. The computer program product of claim 18, wherein the previous mobile telephone is a recyclable/disposable telephone.

20. The computer program product of claim 19, wherein the first call made from the mobile telephone is dialed to a first telephone number, but is routed to a second telephone number.

21. The computer program product of claim 20, wherein the step of determining that the newly activated mobile telephone is newly activated comprises the step of:
determining that the newly activated mobile telephone is newly activated based on a mobile identification number of the newly activated mobile telephone.

22. The computer program product of claim 21, wherein the step of determining whether a user of the newly activated mobile telephone is a returning user of a previous mobile telephone comprises the step of:
prompting the user to input information using the newly activated mobile telephone that indicates whether the user is a returning user of a previous mobile telephone.

23. The computer program product of claim 22, wherein the step of obtaining from the user of the newly activated mobile telephone a telephone number of the previous mobile telephone comprises the steps of:
prompting the user to input information indicating whether the user desires to keep or use the telephone number of the previous mobile telephone for the newly activated mobile telephone; and
prompting the user to enter the telephone number of the previous mobile telephone.

24. The computer program product of claim 23, further comprising the step of:
determining whether the telephone number of the previous mobile telephone is currently inactive.

25. A system for re-use of a terminating telephone number with multiple mobile telephones comprising:
a server platform connected to a public switch telephone network and to a mobile switching center of a mobile telephone network and operable to receive calls from the public switch telephone network and from mobile telephones in the mobile telephone network and operable to place calls to the public switch telephone network and to mobile telephones in the mobile telephone network, the server platform comprising:
a server operable to receive a call from a newly activated mobile telephone, the call being a first call made from the mobile telephone, determine that the newly activated mobile telephone is newly activated, determine whether a user of the newly activated mobile telephone is a returning user of a previous mobile telephone, obtain from the user of the newly activated mobile telephone a telephone number of the previous mobile telephone, and assign the telephone number of the previous mobile telephone to the newly activated mobile telephone.

26. The system of claim 25, wherein the newly activated mobile telephone is a recyclable/disposable telephone.

27. The system of claim 26, wherein the previous mobile telephone is a recyclable/disposable telephone.

28. The system of claim 27, wherein the first call made from the mobile telephone is dialed to a first telephone number, but is routed to a second telephone number.

29. The system of claim 28, wherein the server is operable to determine that the newly activated mobile telephone is newly activated based on a mobile identification number of the newly activated mobile telephone.

30. The system of claim 29, wherein the server platform further comprises an interactive voice response unit operable to prompt the user to input information using the newly activated mobile telephone that indicates whether the user is a returning user of a previous mobile telephone.

31. The system of claim 30, wherein the server platform further comprises an interactive voice response unit operable to prompt the user to input information indicating whether the user desires to keep or use the telephone number of the previous mobile telephone for the newly activated mobile telephone and prompting the user to enter the telephone number of the previous mobile telephone.

32. The system of claim 31, wherein the server platform further comprises a database comprising information relating to the telephone number of the previous mobile telephone is currently inactive.

33. The system of claim 32, wherein the server is further operable to access the database to determine whether the telephone number of the previous mobile telephone is currently inactive.
